(19) United States
(12) Patent Application Publication
(10) Pub. No.: US 2016/0098916 A1
(43) Pub. Date: Apr. 7, 2016

(54) MOBILE SECURITY SYSTEM AND METHOD

(71) Applicant: Gregg E Bieser, Glenview, IL (US)

(72) Inventor: Gregg E Bieser, Glenview, IL (US)

(21) Appl. No.: 14/875,243

(22) Filed: Oct. 5, 2015

Related U.S. Application Data
(60) Provisional application No. 62/059,944, filed on Oct. 5, 2014.

(51) Int. Cl. G08B 25/10

(52) U.S. Cl. CPC G08B 25/10

(57) ABSTRACT

Embodiments relate to a mobile security device, system and method. The mobile security device includes a base and at least one sensor. The base has a housing defining a first end and a second end. The base includes a base power source and a base controller coupled to the base power source and configured for wireless communication. The at least one sensor is removably coupled to the first end of the base and communicates therewith. The at least one sensor is configured to provide at least one of motion sensing, CO2/smoke sensing, vibration sensing, light sensing, and temperature/humidity sensing. The at least one sensor includes a sensor housing; a sensor power source; and a sensor controller coupled to the sensor power source and configured for wireless communication.

### CLAIM FOR PRIORITY

This application claims priority from U.S. Provisional Application Ser. No. 62/059,944 filed Oct. 5, 2014, the complete subject matter of which is incorporated herein by reference in its entirety.

### FIELD OF THE INVENTION

The invention relates generally to a security device. More specifically, the present invention relates to a portable, mobile security device, system and method.

### BACKGROUND OF THE INVENTION

Embodiments of the present invention relate to security. Few human needs are as fundamental and timeless as personal safety and security . . . and few have been more explosively changed by the proliferation of smart phones and the recent realization of device “connectedness” technologies. Witness the rise of remote access keyless locks, Internet-ready multi-sensor security systems, and even “smart home” automation and awareness hubs . . . it's an old itch with a new scratch.

But these advances are centered around the home and people are not . . . people are in motion . . . people travel . . . and whether to a local office or a distant city, whether on business or on pleasure, whether for just the day or many weeks, risk travels with them . . . risk of theft in-transit, risk of intrusion on-site, risk of undetected catastrophe . . . and far from the security of home.

For the foregoing reasons, it would be desirable to provide a mobile device, system and method that is easy to use. It would be desirable to provide a fully self-contained, compact, multi-sensor security system designed specifically for security on the move. It would be even more desirable to provide supplemental awareness of specific security risks (motion, smoke/CO, sound, light, and the like and inform the user via ALERTs (text/e-mail), ALARMs (audio), both or through some other means.

### SUMMARY OF THE INVENTION

Embodiments relate to a fully self-contained, compact, multi-sensor security system designed specifically for security on the move. The base can stand alone, providing motion detection, visuals via an optional camera, and in-transit monitoring of belongings. If a security event occurs, the system informs the user via ALERTs (text/e-mail), ALARMs (audio), both or through some other means. For more comprehensive protection, add one or more tiny wireless sensors, each sensor providing supplemental awareness of specific security risks (motion, smoke/CO, sound, light, and the like). The base monitors these elements, reporting immediately when security issues occur. When not in use, these elements lock onto the base for travel convenience and charge their batteries from the base power source.

Embodiments relate to a mobile security device, system and method. The device includes a base and at least one sensor. The base has a housing defining a first end and a second end. The base includes a base power source and a base controller coupled to the base power source and configured for wireless communication. The at least one sensor is removably coupled to the first end of the base and communicates therewith. The at least one sensor is configured to provide at least one of motion sensing, CO2/smoke sensing, vibration sensing, light sensing, and temperature/humidity sensing. The at least one sensor includes a sensor housing; a sensor power source; and a sensor controller coupled to the sensor power source and configured for wireless communication.

Another embodiment relates to a mobile security system including a base, first, second and third sensors, and first and second proximity tags. The base has a housing defining a first end and a second end, and includes a base power source; a base controller coupled to the power source and configured for wireless communication; a speaker coupled to at least one of the base power source and the base controller; and a camera coupled to at least one of the base power source and the base controller. The first sensor is removably coupled to the first end of the base and communicates therewith, the first sensor is configured to provide at least one of motion sensing, CO2/smoke sensing, vibration sensing, light sensing, and temperature/humidity sensing, where the first sensor includes a first sensor housing; a first sensor power source; and a first sensor controller coupled to the first sensor power source and configured for wireless communication. The second sensor is removably coupled proximate the first end of the base and communicates therewith, the second sensor is configured to provide at least one of motion sensing, CO2/smoke sensing, vibration sensing, light sensing, and temperature/humidity sensing, the second sensor including a second sensor housing; a second sensor power source; and a second sensor controller coupled to the power source and configured for wireless communication. The third sensor is removably coupled proximate the first end of the base and communicates therewith, the third sensor is configured to provide at least one of motion sensing, CO2/smoke sensing, vibration sensing, light sensing, and temperature/humidity sensing, the third sensor including a third sensor housing; a third sensor power source; and a third sensor controller coupled to the third sensor power source and configured for wireless communication. The first proximity tag is adapted to attach to a bag and/or belongings and communicates with at least the base, the first proximity tag configured to provide approximate distance-from-base information, the first proximity tag including a first proximity tag housing; a first proximity tag power source; and a first proximity tag controller coupled to the first proximity tag power source and configured for wireless communication. The second proximity tag is adapted to attach to a bag and/or belongings and communicates with at least the base, the second proximity tag configured to provide approximate distance-from-base information, the second proximity tag includes a second proximity tag housing; a second proximity tag power source; and a second proximity tag controller coupled to the second proximity tag power source and configured for wireless communication.

Yet another embodiment relates to a method for providing security using a mobile security device, the mobile security device including a base and at least one proximity tag. The base has a housing defining a first end and a second end, and includes a base power source; a base controller coupled to the base power source and configured for wireless communication; a speaker coupled to at least one of the base power source and the base controller; a camera coupled to at least one of the base power source and the base controller; and a touch pad coupled to at least one of the base power source and the base controller. The at least one proximity tag is configured to attach to a bag and/or belongings and communicate with the base. The at least one proximity tag is configured to provide approximate distance-from-base information, the at least one proximity tag including a proximity tag housing; a proximity tag power source; a proximity tag controller coupled to the proximity tag power source and configured for wireless communication. The method includes independently powering-up the at least one proximity tag; placing the at least one proximity tag on a bag and/or belongings; initiating proximity monitoring from the base; arming the base and the at least one proximity tag; monitoring the at least one proximity tag for proximity states; and base ALARMing and ALERTing when changes in proximity state of the at least one proximity tag occur.

Still another embodiment relates to a method for providing security using a mobile security device. The mobile security device includes a base and a sensor. The base has a housing defining a first end and a second end, and includes a base power source; a base controller coupled to the base power source and configured for wireless communication; a speaker coupled to at least one of the base power source and the base controller; a camera coupled to at least one of the base power source and the base controller; and a touch pad coupled to at least one of the base power source and the base controller. The at least one sensor is removably coupled to the first end of the base and communicates therewith, the at least one sensor configured to provide at least one of motion sensing, CO2/smoke sensing, vibration sensing, light sensing, and temperature/humidity sensing. The at least one sensor includes a sensor housing; a sensor power source; and a sensor controller coupled to the sensor power source and configured for wireless communication. The method includes detaching the at least one sensor auto-activating the sensor; positioning the at least one sensor to at least one risk point in a security zone; initiating at least one of watch-only and watch-and-warn sensor monitoring from the base; arming the base and the at least one sensor; monitoring the at least sensor for heartbeats; monitoring the at least sensor for security events; performing at least one of base ALERTing, base ALARMing and base ALERTing and ALARMing when missed heartbeats or security events occur in the at least one sensor; and disarming the base and the at least one sensor.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a front view of the device in accordance with one embodiment of the present invention;

FIG. 2 illustrates a back view of the device of FIG. 1 in accordance with one embodiment of the present invention;

FIG. 3 illustrates a front perspective view of the device of FIG. 1 in accordance with one embodiment of the present invention;

FIG. 4 illustrates another front perspective view of the device of FIG. 1 in accordance with one embodiment of the present invention;

FIG. 5 illustrates a back perspective view of the device of FIG. 1 in accordance with one embodiment of the present invention;

FIG. 6 illustrates the internal components of the device of FIG. 1 in accordance with one embodiment of the present invention;

FIG. 7 illustrates a perspective view of the sensor of FIG. 1 in accordance with one embodiment of the present invention;

FIGS. 8A-8F illustrate another embodiment of the device used in a TRAVEL mode with the a plurality of proximity tags in accordance with one embodiment of the present invention;

FIG. 9 illustrates the internal components of the proximity tags; and

FIGS. 10A-10E illustrate the embodiment of the device with the sensors deployed in a SURVAIL/SECURE mode in accordance with one embodiment of the present invention.

Throughout the various figures, like reference numbers refer to like elements.

### DETAILED DESCRIPTION OF PRESENTLY PREFERRED EMBODIMENTS

Few human needs are as fundamental and timeless as personal safety and security . . . and few needs have been more explosively changed by the proliferation of smart phones and the recent realization of device “connectedness” technologies. Witness the rise of remote access keyless locks, Internet-ready multi-sensor security systems, and even “smart home” automation and awareness hubs . . . it's an old itch with a new scratch. Embodiments of the present invention scratch that itch. Embodiments of the present invention relate to personal safety and security. More specifically embodiments of the present invention relate to a portable, mobile security system and method.

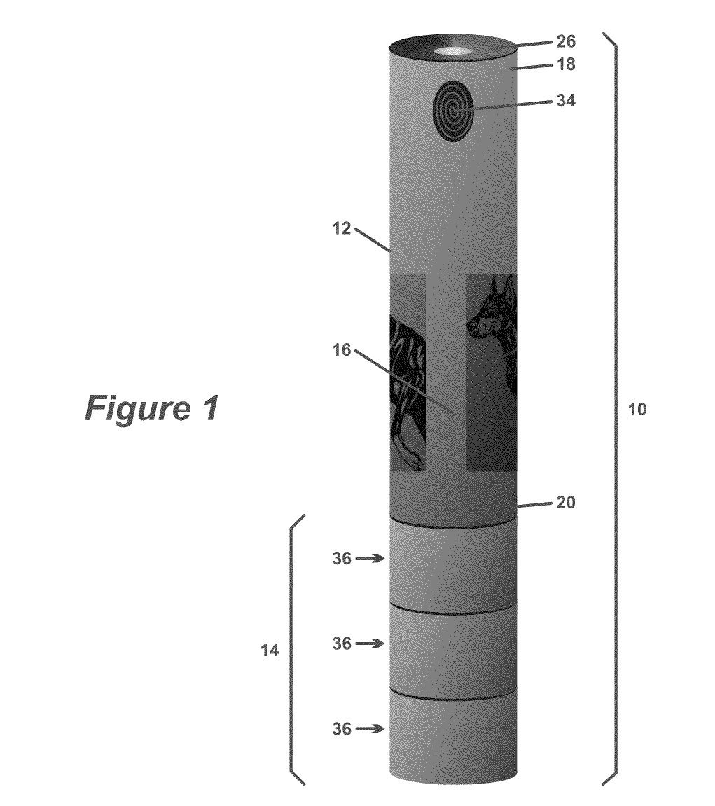

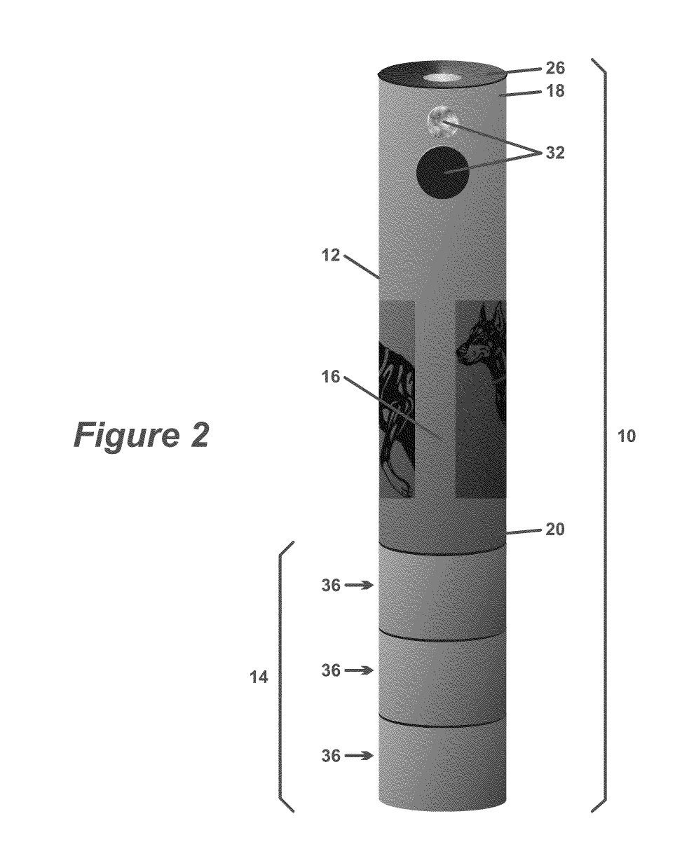

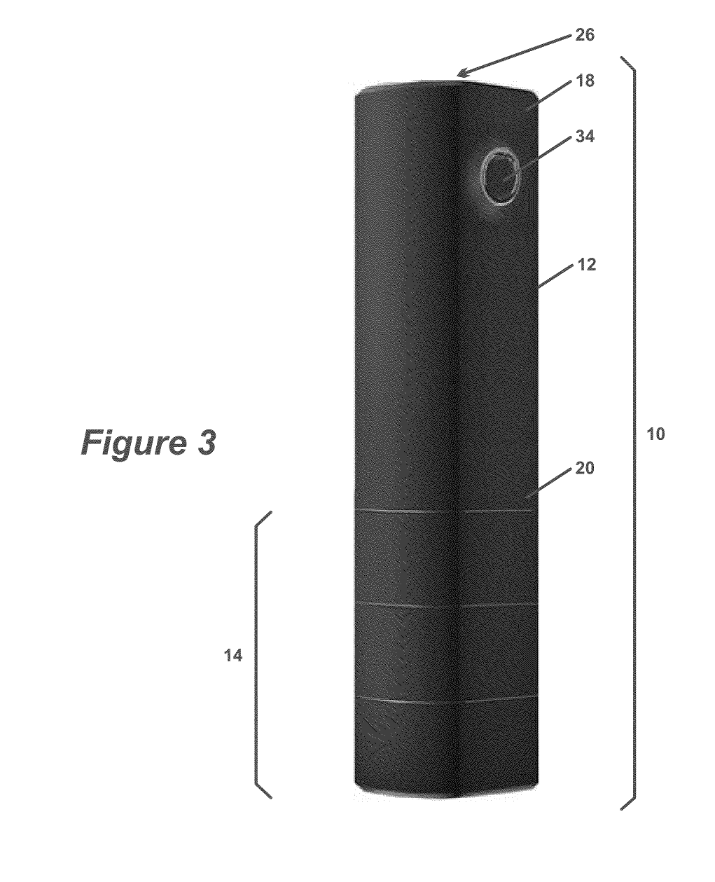

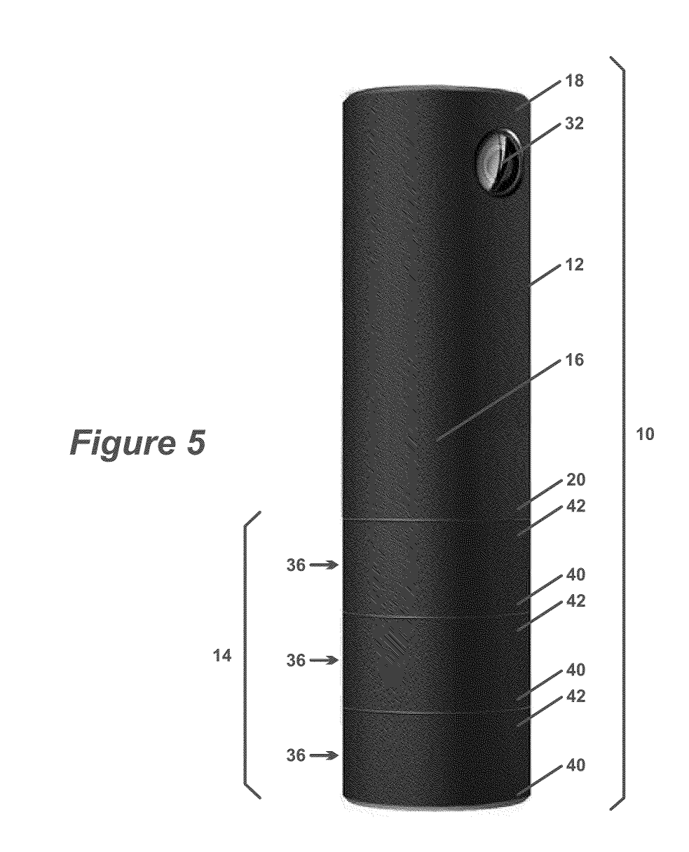

FIGS. 1-5 depict a mobile security device, generally designated 10, in accordance with one embodiment of the present invention. In at least one embodiment, the mobile security system 10 operates in one or more modes: TRAVEL (proximity monitoring for proximity tags); SURVAIL (silent observation—ALERTs but no ALARMs); and SECURE (full “watch-and-warn” security system—ALERTs and ALARMs). The mobile security system 10 includes a rapid deploy and arm sequence (less than 30 seconds from assembled “inert” system to actively monitoring) providing personal safety and security.

The illustrated mobile security device 10 is relatively small, with a diameter of about 1.5″ and an overall length of about 8.5″ and able to fit in about any bag or purse. As depicted, the mobile security system 10 includes a base 12 (having a length of about 5.5″) and one or more elements 14, each element about 1″ in length. FIGS. 1-5 depict the mobile security device 10 having an elongated, cylindrical-like shape, although other shapes are contemplated.

FIGS. 1-5 depict the base 12 having a housing 16 defining a second end 18 and a first end 20. FIG. 1 depicts the mobile security device 10 having an elongated, cylindrical-like shape which minimizes “catching” on bag/contents, minimizing the risk of damage to the bag/contents, although other shapes are contemplated. Further housing 16 has an anti-slip exterior finish that resists scratches. It should be appreciated that the dimensions and exterior are illustrative only, and other sizes and dimensions are contemplated.

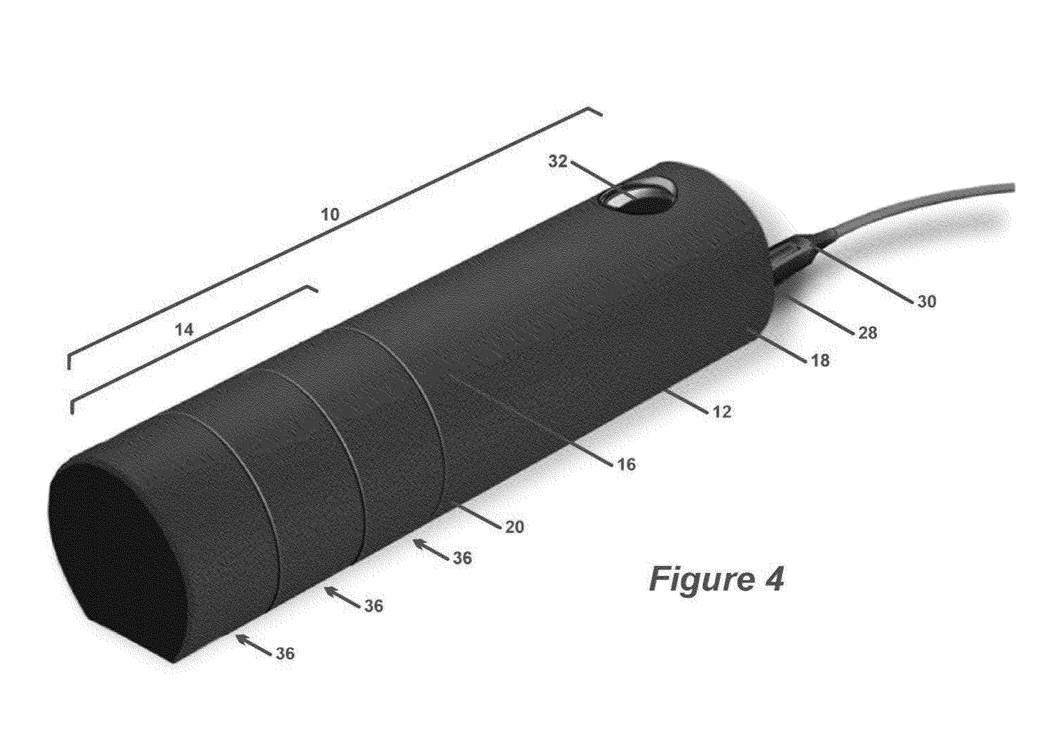

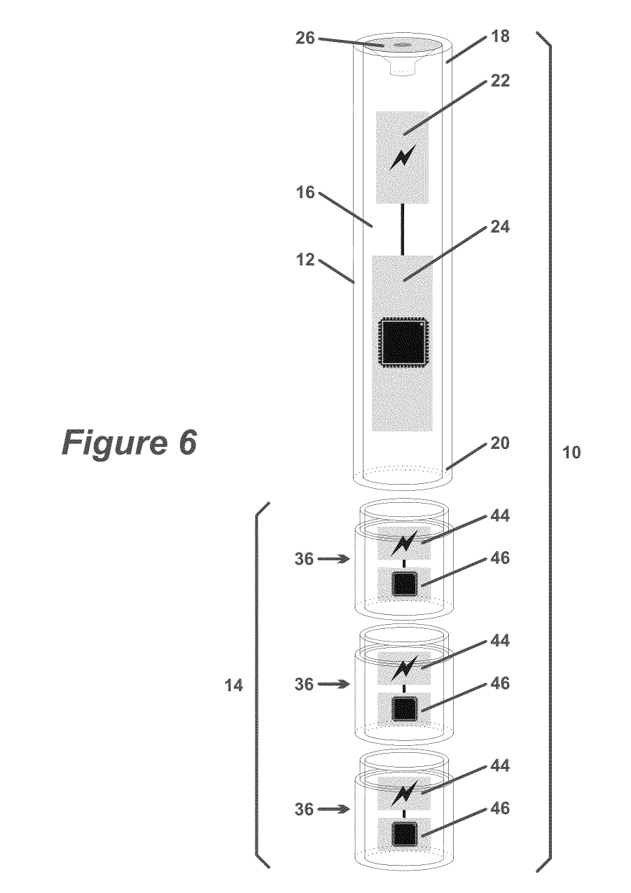

As depicted in FIG. 6, the base 10 includes at least a rechargeable base power source 22 and a base controller 24 connected thereto. Base power source 22 enables extended operation of the base 10 and elements 14 while the base controller 24 is configured for wireless communication with a wireless communication device such as a smartphone, PDA, laptop and the like. FIGS. 1 & 3 further illustrate a speaker 26 coupled to at least one or both of the base power source 22 and the base controller 24. The mobile security device 10 further includes a jack 28 (best viewed in FIG. 4). Jack 28 is adapted to removeably receive a USB charging cord 30 to charge the base power source 22.

In at least one embodiment, the base 12 further includes at least one camera 32 coupled to at least one of the base power source 22 and the base controller 24. Further, the base 12 further includes at least one touch pad 34 communicating with at least the base controller 24 to select different modes of operation.

In at least one embodiment, the one or more elements 14 comprise one or more sensors 36. FIGS. 1-5 illustrate three sensors 36 coupled to the base 12 at or proximate first end 20. While three sensors 36 are illustrated, more or less than three sensors 36 are contemplated. FIG. 1-5 illustrates a first sensor 36 removably coupled to the first end 20 of base 12 and communicating therewith, a second sensor 36 removably coupled to the first sensor 36 proximate first end 20 and a third sensor 36 removably coupled to the second sensor 36 proximate first end 20. Each of the sensors 36 is about 1″ in length.

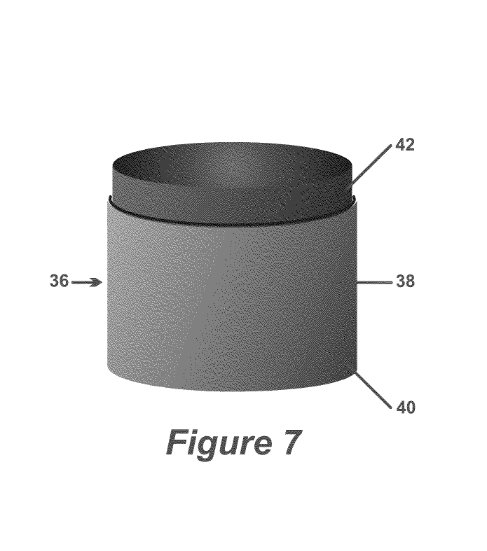

FIG. 7 depicts the sensor 36 having a housing 38 defining a first end 40 and a second end 42. FIG. 7 depicts the sensor 36 having a cylinder like shape which minimizes “catching” on bag/contents, minimizing the risk of damage to the bag/contents, although other shapes are contemplated. Further housing 38 has an anti-slip exterior finish that resists scratches. It should be appreciated that the dimensions and exterior are illustrative only, and other sizes and dimensions are contemplated. Each sensor 36 has a first end 40 and second end 42 opposite the first end 40, where the second end 42 is adapted to removably connect or couple to the base 12 or another sensor 36. FIGS. 1-5 depict the second end 42 of the first sensor 36 is coupled to or proximate the first end 20, the second end 42 of the second sensor 36 is coupled to the first end 40 of the first sensor 36 proximate end 20, while the second end 42 of the third sensor 36 is coupled to the first end 40 of the second sensor 36.

As depicted in FIG. 6, each of the sensors 36 includes at least a rechargeable sensor power source 44 and a sensor controller 46 connected thereto. Each sensor power source 44 enables extended operation of the sensor 36 while the sensor controller 46 is configured for wireless communication to a wireless communication device such as a smartphone, PDA, laptop and the like.

In at least one embodiment, the one or more elements 14 comprise one or more sensors 36. FIGS. 1-5 illustrate three sensors 36 coupled to the base 12 at or proximate first end 20. While three sensors 36 are illustrated, more or less than three sensors 36 are contemplated. FIGS. 1-5 illustrates a first sensor 36 removably coupled to the first end 20 of base 12 and communicating therewith, a second sensor 36 removably coupled to the first sensor 36 proximate first end 20 and a third sensor 36 removably coupled to the second sensor 36 proximate first end 20.

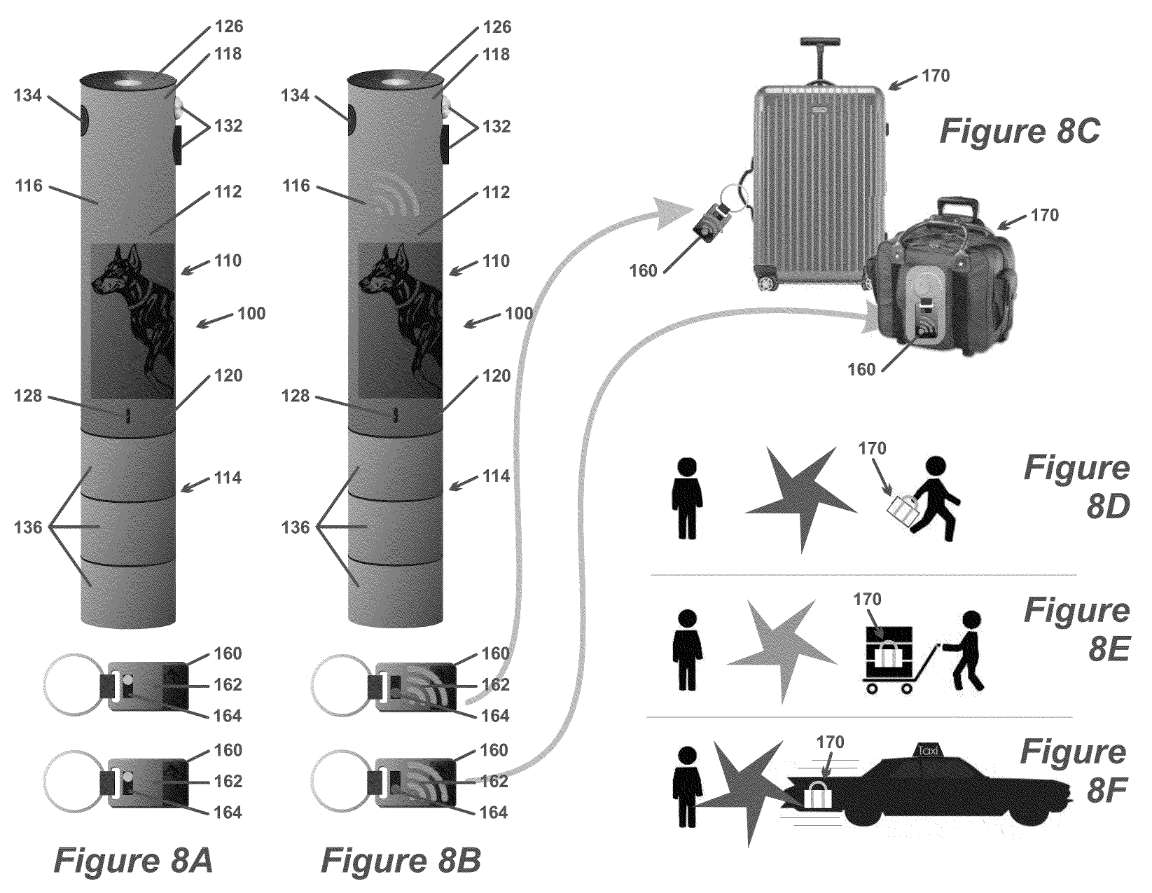

FIGS. 8A-8F depict a mobile security system, generally designated 100, in accordance with one embodiment of the present invention. In at least one embodiment, the mobile security system 100 operates in one or more modes. FIGS. 8A-8E depicts the mobile security system 100 includes a mobile device 110 operating in a TRAVEL mode or proximity monitoring one or more proximity tags 160. In this embodiment the mobile security system watches the user's bags and/or belongings to be sure they stay close.

FIGS. 8A-8B depict the base 112 having a housing 116 defining a first end 120 and a second end 118. FIG. 8A-8B depicts the mobile security device 110 having an elongated, cylindrical-like shape which minimizes “catching” on bag/contents, minimizing the risk of damage to the bag/contents, although other shapes are contemplated. Further housing 116 has an anti-slip exterior finish that resists scratches. It should be appreciated that the dimensions and exterior are illustrative only, and other sizes and dimensions are contemplated.

Similar to the device 10 above, device 110 includes a base 112 having at least a rechargeable base power source 22 and a base controller 24 connected thereto. Base power source 22 enables extended operation of the base 112 and elements 114 while the base controller 24 is configured for wireless communication. FIGS. 8A-8B further illustrate a speaker 126 coupled to at least one or both of the base power source 22 and the base controller 24. The mobile security device 110 further includes a jack 128 proximate the first end 120. Jack 128 is adapted to removably receive a USB charging cord to charge the base power source 22.

In at least one embodiment, the base 112 further includes at least one camera 132 coupled to at least one of the base power source 22 and the base controller 24. Further, the base 112 further includes at least one touch pad 134 communicating with at least the base controller 24.

In at least one embodiment, the one or more elements 114 comprise one or more sensors 136, the at least one or more sensors 136 configured to provide at least one of motion sensing, CO2/smoke sensing, vibration sensing, light sensing, temperature/humidity sensing and the like. FIGS. 8A-8B illustrate three sensors 136 similar to the sensors described above coupled to the base 112 at or proximate first end 120. While three sensors 136 are illustrated, more or less than three sensors 136 are contemplated. FIGS. 8A-8B illustrates a first sensor 136 removably coupled to the first end 120 of base 112 and communicating therewith, a second sensor 136 removably coupled to the first sensor 136 proximate first end 120 and a third sensor 136 removably coupled to the second sensor 136 proximate first end 120. Each of the sensors 136 is about 1″ in length.

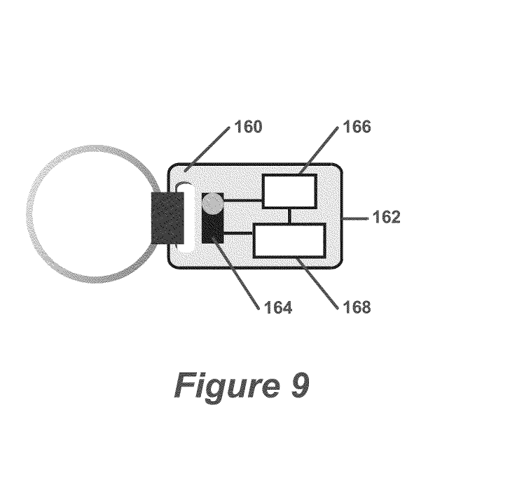

Additionally, the mobile security system 100 illustrated in FIGS. 8A-8B includes a plurality of proximity tags 160 configured for removable attachment to a bag and/or belongings 170 (see FIG. 8C) and communicating with the base 112. While two proximity tags 160 are illustrated, more or less than two proximity tags 160 are contemplated. As depicted in FIG. 9 each of the proximity sensors 160 includes at least a proximity tag housing 162, an on/off switch 164, a proximity tag power source 166 and a proximity tag controller 168 connected thereto. Each proximity tag power source 166 enables extended operation of the proximity tag 160 when turned on or enabled using on/off switch 164 while the proximity tag controller 168 is configured for wireless communication with the base for example.

The at least one proximity tag 160 is configured for attachment to the bag or belongings 170 and communicating with the base 112 as illustrated in FIG. 8C. The at least one proximity tag 160 is configured to provide approximate distance-from-base information. In operation, the at least one proximity tag 160 is independently powered-up moving the at least one on/off switch 164 (See FIG. 8B). The at least one proximity tag 160 is placed on or concealed in the bag and/or belongings 170 as shown in FIG. 8C. The system 100 initiates proximity monitoring from the base 112. The system 100 arms the base 110 and the at least one proximity tag 160 and monitors the at least one proximity tag 160 for proximity states. The system 100 enables base ALARMing and ALERTing when changes in proximity state of the at least one proximity tag 160 occur.

In at least one embodiment, the mobile security system 100 initiates proximity monitoring from the base 112 by powering up the base 112 and selecting proximity monitoring mode or TRAVEL mode from a plurality of modes using the at least one touch pad 134 communicating with at least the base controller 24. In this embodiment, arming the base 112 and the at least one proximity tag 160 comprises the base 112 searching for, finding, and communicating with the at least one proximity tag 160. Monitoring the at least one proximity tag 160 for proximity states (illustrated in FIGS. 8D-8F) comprises monitoring the at least one proximity tag 160 in a passive interaction mode; detecting if the at least one proximity tag 160 enters an in-range state; detecting if the at least one proximity tag 160 enters an out-of-range state; detecting if the at least one proximity tag 160 enters an in-motion state; and rapid detection of change in a proximity state. System 100 enables base 112 ALARMing and ALERTing when changes in proximity state of the at least one proximity tag 160 occur which includes giving audio feedback via base speaker 126 (ALARMing) and the base 112 sending information about proximity state via SMS, e-mail, and/or other communication pathway (ALERTing) to a wireless communication device such as a smartphone, PDA, laptop and the like. The securing method of claim 21 wherein disarming the base 112 and the at least one proximity tag 160 includes powering down the base 112; and physically detaching the at least one proximity tag 160 from the bag or belongings 170.

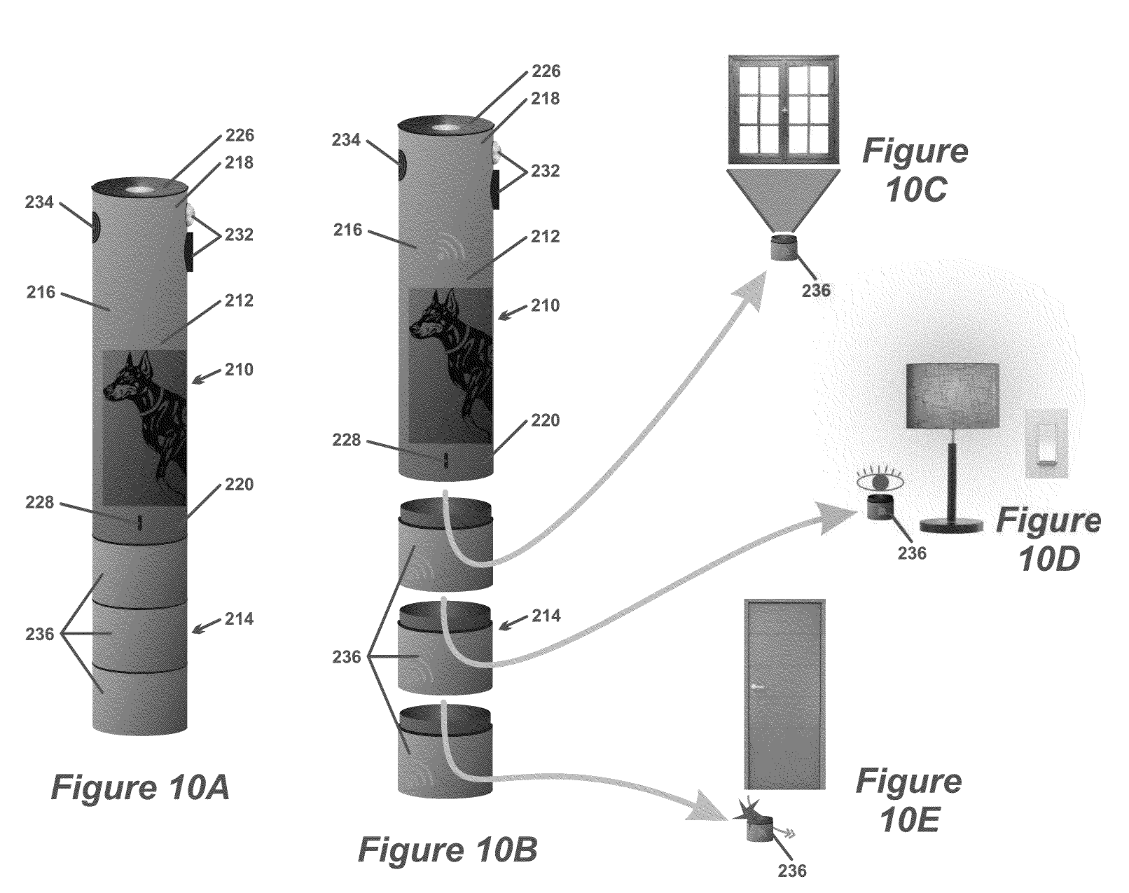

FIGS. 10A-10E depict a mobile security device, generally designated 210, in accordance with one embodiment of the present invention. In at least one embodiment, the mobile security system 210 operates in one or more modes. FIGS. 10A-10E depicts the mobile security device 210 operating in a one of a SURVAIL or SECURE mode.

FIGS. 10A-10B depict the base 212 having a housing 216 defining a second end 218 and a first end 220. FIG. 10A-10B depict the mobile security device 210 having an elongated, cylindrical-like shape which minimizes “catching” on bag/contents, minimizing the risk of damage to the bag/contents, although other shapes are contemplated. Further housing 216 has an anti-slip exterior finish that resists scratches. It should be appreciated that the dimensions and exterior are illustrative only, and other sizes and dimensions are contemplated.

Similar to the device 10 above, device 210 includes a base 212 having at least a rechargeable base power source 22 and a base controller 24 connected thereto. Base power source 22 enables extended operation of the base 212 and elements 214 while the base controller 24 is configured for wireless communication. FIGS. 10A-10B further illustrate a speaker 226 coupled to at least one or both of the base power source 22 and the base controller 24. The mobile security device 210 further includes a jack 228 proximate the first end 220. Jack 228 is adapted to removably receive a USB charging cord to charge the base power source 22.

In at least one embodiment, the base 212 further includes at least one camera 232 coupled to at least one of the base power source 22 and the base controller 24. Further, the base 212 further includes at least one touch pad 234 communicating with at least the base controller 24.

In at least one embodiment, the one or more elements 214 comprise one or more sensors 236 configured to provide at least one of motion sensing, CO2/smoke sensing, vibration sensing, light sensing, temperature/humidity sensing, and the like. FIGS. 10A-10B illustrate three sensors 236 similar to the sensors describe above coupled to the base 212 at or proximate second end 218. While three sensors 236 are illustrated, more or less than three sensors 236 are contemplated. FIGS. 10A-10B illustrates a first sensor 236 removably coupled to the first end 220 of base 212 and communicating therewith, a second sensor 236 removably coupled to the first sensor 236 proximate first end 220 and a third sensor 236 removably coupled to the second sensor 236 proximate first end 220. Each of the sensors 236 is about 1″ in length.

In at least one embodiment, the method for providing security using the mobile security device 210 includes the at least one sensor removably coupled to the first end of the base and communicating therewith, the at least one sensor configured to provide at least one of motion sensing, CO2/smoke sensing, vibration sensing, light sensing, and temperature/humidity sensing, the at least one sensor similar to any of the sensors discussed above. The method includes detaching the at least one sensor 236 auto-activating the sensor 236. The at least one sensor 236 is positioned proximate at least one risk point in a security zone (See FIGS. 10C-10E).

The method further includes initiating at least one of a watch-only and watch-and-warn sensor monitoring from the base 212; arming the base 212 and the at least one sensor 236; monitoring the at least sensor 236 for heartbeats; monitoring the at least sensor 236 for security events; performing at least one of base ALERTing, base ALARMing and base ALERTing and base ALARMing when missed heartbeats or security events occur in the at least one sensor 236; and disarming the base 212 and the at least one sensor 236.

The method further includes auto-activating the at least one sensor 236 which includes physically detaching the at least one sensor 236 from the base housing 216 (See FIG. 10B) so that the sensor 236 automatically powers up and becomes receptive to communication from the base 212. The at least one sensor 236 is positioned to at least one risk point in a security zone comprises placing the at least one sensor 236 in a location to detect changes in the local environment likely to represent a security issue related to at least one of windows, doors, light sources, water sources, fire sources, gas sources and the like (See FIGS. 10C-10E).

The securing method includes initiating watch-only sensor monitoring from the base 212 comprises powering up the base 212 and selecting watching-only mode or SURVAIL mode from a plurality of modes using the at least one touch pad 234 communicating with at least the base controller 24. In another embodiment, initiating watch-and-warn sensor monitoring from the base 212 comprises powering up the base 212 and selecting watching-and-warn mode or SECURE mode from a plurality of modes using the at least one touch pad 234 communicating with at least the base controller 24. Arming the base 212 and the at least one sensor 236 include the base 212 searching for, finding, and communicating with the at least one sensor 236.

In at least one embodiment, monitoring the at least one sensor 236 for heartbeats includes the at least one sensor 236 customizing the base's heartbeat interaction with the sensor 236; the base 212 maintaining an active communication channel with the at least one sensor 236; and the base 212 periodically pinging the at least one sensor 236 and the at least one sensor 236 responding to the pinging over an active communication channel.

In another embodiment, monitoring the at least one sensor 236 for security events comprises the at least one sensor 236 monitoring for changes in local environment likely to represent a security issue; the at least one sensor 236 sending information about the security event in a standardized form to the base 212 via an active communication channel; and the base 212 receiving security event information in standardized form from the at least one sensor 236 via the active communication channel.

The securing method further includes base ALERTing when missed heartbeats or security events occur in the at least one sensor 236 includes the base 212 sending information about the at least one sensor's missed heartbeat or security event info via SMS, e-mail, and/or other communication pathway (ALERTing) to a wireless communication device such as a smartphone, cellphone, PDA, laptop and the like. Alternatively, the securing method includes base ALERTing when missed heartbeats or security events occur in the at least one sensor 236 comprises giving audio feedback via base speaker 226 (ALARMing) and the base 212 sending information about the at least one sensor's missed heartbeat or security event info via SMS, e-mail, and/or other communication pathway (ALERTing) to a wireless communication device such as a smartphone, cellphone, PDA, laptop and the like. Disarming the base 212 and the at least one sensor 236 comprises powering down the base 212; and physically reattaching the at least one sensor 236 to the base housing 216 which results in auto-power-down of the at least one sensor 236.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A mobile security device, the device comprising:
a base having a housing defining a first end and a second end, the base comprising:
a base power source;
a base controller coupled to the base power source and configured for wireless communication; and
at least one sensor removably coupled to the first end of the base and communicating therewith, the at least one sensor configured to provide at least one of motion sensing, CO2/smoke sensing, vibration sensing, light sensing, and temperature/humidity sensing, the at least one sensor comprising:
a sensor housing;
a sensor power source; and
a sensor controller coupled to the sensor power source and configured for wireless communication.

2. The mobile security device of claim 1 further comprising a touch pad in communication with at least the base controller, the touch pad enabling selecting at least one of a TRAVEL mode, a SURVAIL mode, and a SECURE mode from a plurality of operation modes.

3. The mobile security device of claim 1 wherein the base housing includes a jack enabling an charger to removably connect to and charge the base power source and the at least one sensor power source.

4. The mobile security device of claim 1 wherein the at least one sensor is in an auto-deactivated, charging mode when attached to the base.

5. The mobile security device of claim 1 wherein the at least one sensor is in an auto-activated mode when detached from the base.

6. The mobile security device of claim 1 wherein the base controller wirelessly communicates with at least one mobile communication device.

7. A mobile security system, the system comprising:
a base having a housing defining a first end and a second end, the base comprising:
a base power source;
a base controller coupled to the power source and configured for wireless communication;
a speaker coupled to at least one of the base power source and the base controller; and
a camera coupled to at least one of the base power source and the base controller;
a first sensor removably coupled to the first end of the base and communicating therewith, the first sensor configured to provide at least one of motion sensing, CO2/smoke sensing, vibration sensing, light sensing, and temperature/humidity sensing, the first sensor comprising:
a first sensor housing;
a first sensor power source; and
a first sensor controller coupled to the first sensor power source and configured for wireless communication;
a second sensor removably coupled proximate the first end of the base and communicating therewith, the second sensor configured to provide at least one of motion sensing, CO2/smoke sensing, vibration sensing, light sensing, and temperature/humidity sensing, the second sensor comprising:
a second sensor housing;
a second sensor power source; and
a second sensor controller coupled to the second sensor power source and configured for wireless communication;
a third sensor removably coupled proximate the first end of the base and communicating therewith, the third sensor configured to provide at least one of motion sensing, CO2/smoke sensing, vibration sensing, light sensing, and temperature/humidity sensing, the third sensor comprising:
a third sensor housing;
a third sensor power source; and
a third sensor controller coupled to the third sensor power source and configured for wireless communication;
a first proximity tag for attachment to a bag and/or belongings and communicating with at least the base, the first proximity tag configured to provide approximate distance-from-base information, the first proximity tag comprising:
a first proximity tag housing;
a first proximity tag power source; and
a first proximity tag controller coupled to the first proximity tag power source and configured for wireless communication; and
a second proximity tag for attachment to a bag and/or belongings and communicating with at least the base, the second proximity tag configured to provide approximate distance-from-base information, the second proximity tag comprising:
a second proximity tag housing;
a second proximity tag power source; and
a second proximity tag controller coupled to the second proximity tag power source and configured for wireless communication.

8. The mobile security system of claim 7 further comprising a touch pad in communication with the base controller, the touch pad enabling selecting at least one of a TRAVEL mode, a SURVAIL mode, and a SECURE mode from a plurality of operation modes.

9. The mobile security system of claim 7 wherein the base housing includes a jack enabling a charger to removably connect to and charge the base power source and at least one of the first, second and third sensor power sources.

10. The mobile security system of claim 7 wherein the first, second and third sensors are in an auto-deactivated, charging mode when attached to the base.

11. The mobile security system of claim 7 wherein the first, second and third sensors are auto-activated when detached from the base.

12. The mobile security system of claim 7 wherein the first and second proximity tags are not attached to the base and at least one of the first and second proximity tags is independently powered-up and activated.

13. The mobile security system of claim 7 wherein the first and second proximity tags are not attached to the base and at least one of the first and second proximity tags is independently powered-down.

14. The mobile security system of claim 7 wherein the base controller wirelessly communicates with at least one mobile communication device.

15. A method for providing security using a mobile security device,
the mobile security device comprising:
a base having a housing defining a first end and a second end, the base comprising:
a base power source;
a base controller coupled to the base power source and configured for wireless communication;
a speaker coupled to at least one of the base power source and the base controller;
a camera coupled to at least one of the base power source and the base controller; and
a touch pad coupled to at least one of the base power source and the base controller;
at least one proximity tag for attachment to a bag or belongings and communicating with the base, the at least one proximity tag configured to provide approximate distance-from-base information, the at least one proximity tag comprising:
a proximity tag housing;
a proximity tag power source;
a proximity tag controller coupled to the proximity tag power source and configured for wireless communication. the method comprising:
independently powering-up the at least one proximity tag;
placing the at least one proximity tag on a bag and/or belongings;
initiating proximity monitoring from the base;
arming the base and the at least one proximity tag;
monitoring the at least one proximity tag for proximity states; and
base ALARMing and ALERTing when changes in proximity state of the at least one proximity tag occur.

16. The securing method of claim 15, wherein powering up the at least one proximity tag comprises moving its power switch to on or enabled position.

17. The securing method of claim 16, wherein placing the at least one proximity tag on a bag and/or belongings comprises externally attaching the at least one proximity tag to bag and/or belongings or concealing the at least one proximity tag within the bag and/or belongings.

18. The securing method of claim 17 wherein initiating proximity monitoring from the base comprises powering up the base and selecting proximity monitoring mode or TRAVEL mode from a plurality of modes.

19. The securing method of claim 18, wherein arming the base and the at least one proximity tag comprises the base searching for, finding, and communicating with the at least one proximity tag.

20. The securing method of claim 19, wherein monitoring the at least one proximity tag for proximity states comprises:
monitoring the at least one proximity tag in a passive interaction mode;
detecting if the at least one proximity tag enters an in-range state;
detecting if the at least one proximity tag enters an out-of-range state;
detecting if the at least one proximity tag enters an in-motion state; and
rapid detection of change in a proximity state.

21. The securing method of claim 15, wherein base ALARMing and ALERTing when changes in a proximity state of the at least one proximity tag occur comprises giving audio feedback via base speaker (ALARMing) and the base sending information about proximity state via SMS, e-mail, and/or other communication pathway (ALERTing) to a wireless communication device.

22. The securing method of claim 21 wherein disarming the base and the at least one proximity tag comprises:
powering down the base; and
physically detaching the at least one tag from the bag or belongings.

23. A method for providing security using a mobile security device,
the mobile security device comprising:
a base having a housing defining a first end and a second end, the base comprising:
a base power source;
a base controller coupled to the power source and configured for wireless communication;
a speaker coupled to at least one of the base power source and the base controller;
a camera coupled to at least one of the base power source and the base controller; and
a touch pad coupled to at least one of the base power source and the base controller;
at least one sensor removably coupled to the first end of the base and communicating therewith, the at least one sensor configured to provide at least one of motion sensing, CO2/smoke sensing, vibration sensing, light sensing, and temperature/humidity sensing, the at least one sensor comprising:
a sensor housing;
a sensor power source; and
a sensor controller coupled to the sensor power source and configured for wireless communication;
the method comprising:
detaching the at least one sensor auto-activating the sensor;
positioning the at least one sensor to at least one risk point in a security zone;
initiating at least one of watch-only and watch-and-warn sensor monitoring from the base;
arming the base and the at least one sensor;
monitoring the at least one sensor for heartbeats;
monitoring the at least one sensor for security events;
performing at least one of base ALERTing, base ALARMing and base ALERTing and ALARMing, when missed heartbeats or security events occur in the at least one sensor; and
disarming the base and the at least one sensor.

24. The securing method of claim 23, wherein auto-activating the at least one sensor comprises physically detaching the at least one sensor from the base housing so that the sensor automatically powers up and becomes receptive to communication from the base.

25. The securing method of claim 24, wherein positioning the at least one sensor to at least one risk point in a security zone comprises placing the at least one sensor in a location to detect changes in the local environment likely to represent a security issue related to at least one of windows, doors, light sources, water sources, fire sources and gas sources.

26. The securing method of claim 25 wherein initiating watch-only sensor monitoring from the base comprises powering up the base and selecting watching-only mode or SURVAIL mode from a plurality of modes.

27. The securing method of claim 26 wherein initiating watch-and-warn sensor monitoring from the base comprises powering up the base and selecting watching-and-warn mode or SECURE mode from a plurality of modes.

28. The securing method of claim 27, wherein arming the base and the at least one sensor comprises the base searching for, finding, and communicating with the at least one sensor.

29. The securing method of claim 23, wherein monitoring the at least one sensor for heartbeats comprises:
the at least one sensor customizing the base's heartbeat interaction with the sensor;
the base maintaining an active communication channel with the at least one sensor; and
the base periodically pinging the at least one sensor and the at least one sensor responding to the pinging over an active communication channel.

30. The securing method of claim 23, wherein monitoring the at least one sensor for security events comprises:
the at least one sensor monitoring for changes in local environment likely to represent a security issue;
the at least one sensor sending information about the security event in a standardized form to the base via an active communication channel; and
the base receiving security event information in standardized form from the at least one sensor via the active communication channel.

31. The securing method of claim 23, wherein base ALERTing when missed heartbeats or security events occur in the at least one sensor comprises the base sending information about the at least one sensor's missed heartbeat or security event info via SMS, e-mail, and/or other communication pathway (ALERTing) to a wireless communication device.

32. The securing method of claim 23, wherein base ALERTing when missed heartbeats or security events occur in the at least one sensor comprises giving audio feedback via base speaker (ALARMing) and the base sending information about the at least one sensor's missed heartbeat or security event info via SMS, e-mail, and/or other communication pathway (ALERTing) to a wireless communication device.

33. The securing method of claim 23 wherein disarming the base and the at least one sensor comprises:
powering down the base; and
physically reattaching the at least one sensor to the base housing which results in auto-power-down of the at least one sensor.
